(19) United States
(12) Patent Application Publication
(10) Pub. No.: US 2011/0090340 A1
(43) Pub. Date: Apr. 21, 2011

(54) IMAGE PROCESSING APPARATUS AND IMAGE PROCESSING METHOD

(75) Inventor: Noriyasu Hashiguchi, Kawasaki-shi (JP)

(73) Assignee: CANON KABUSHIKI KAISHA, Tokyo (JP)

(21) Appl. No.: 12/902,849

(22) Filed: Oct. 12, 2010

(30) Foreign Application Priority Data
Oct. 19, 2009 (JP) 2009-240636(PAT.)

(51) Int. Cl. H04N 7/18

(52) U.S. Cl. 348/152; 348/E07.085

(57) ABSTRACT

An image processing apparatus comprises a detection unit that detects an area having a predetermined feature from image data, a selection unit that selects, based on information of the detected area, a transfer method in which a total transfer amount of data is smallest from a plurality of transfer methods whereby the data of the detected area is divided and transferred, and a transfer unit that divides the data of the detected area and transfers from a first storage device in which the image data has been stored to a second storage device by the selected transferring method. The image processing apparatus can minimize a transfer overhead which is caused when image data is divided and transferred.

### BACKGROUND OF THE INVENTION

1. Field of the Invention

The present invention relates to an image processing apparatus and an image processing method.

2. Description of the Related Art

The installation of a surveillance camera has rapidly been spread for the purpose of security. An apparatus for automatically detecting intrusion of a suspicious person or object by using such a camera has been proposed.

For example, in the Official Gazette of Japanese Patent Application Laid-Open No. H05-284501, feature data such as area, moving direction, and moving speed of a target captured in a fetched monitoring area is extracted. As an extracting method, a difference between a processing image and a background is obtained, a labeling process is executed in an image obtained by binarizing the difference, and an area and a center of gravity of the processed image are obtained, thereby capturing the target. The target is compared with feature data of an intruder which has previously been stored. When they coincide, such a target is detected as an intruder and a warning is generated.

Such a technique that image patterns of persons are previously learned by a machine learning and whether or not an object projected to an image is a person is recognized has been known.

For example, in Rowley et al., “Neural network-based face detection”, IEEE TRANSACTIONS ON PATTERN ANALYSIS AND MACHINE INTELLIGENCE, Vol. 20, No. 1, January, 1998, a face pattern in an image is detected by a neural network. Such a detecting method will be simply described hereinbelow. First, image data in which the detection of a face is a target is read into a memory and a predetermined area to be collated with the face is extracted from the read image. Pixel values of the extracted area are input and one output is obtained by an arithmetic operation by the neural network. At this time, a weight and a threshold value of the neural network have previously been learned by a very large quantity of face image patterns and non-face image patterns. For example, when the output of the neural network is equal to or larger than 0, the target is determined as a face, and in the other cases, it is decided as a non-face. Although the above document has been described on the assumption that the image pattern is the face, even if the target is a human body, by previously learning based on human body image patterns, whether or not the target is the human body can be recognized by a process similar to that mentioned above in principle.

By using both of the technique for detecting the change area in those images by the background difference and the technique for discriminating whether or not the object projected to the image is the person, the human body can be detected at high precision. More specifically speaking, the change area detected by the background difference is extracted from the image and held in the memory and the recognizing process of the human body pattern is repetitively executed to a predetermined partial area from the extracted area.

However, if the change area is large, in the case of processing by a system constructed by a memory of a small capacity, such a problem that the images of the change area cannot be held in a lump occurs. Ordinarily, as a method of solving such a problem, a method of dividing the image and processing the divided images has been known. For example, in the Official Gazette of Japanese Patent Application Laid-Open No. 2006-139606, one digital image data is divided into a plurality of band areas, each band area is successively allocated to a band memory, and a local (neighborhood) image process such as a space filter process or the like is executed. The band memory has a capacity corresponding to a predetermined number of pixels which depend on a space filter area and image data which is transferred in predetermined scanning order such as a raster scan is updated in a ring manner.

FIGS. 4A to 4C and FIGS. 5A to 5C illustrate more specific examples in which an image of a change area is divided into a plurality of band areas. FIGS. 4A to 4C are diagrams illustrating the example in which an image 300 of a change area detected in an input image is divided into band areas in the vertical direction and the recognizing process is executed to two band areas 311 and 321. In FIG. 4A, attention is paid to the band area 311. In FIG. 4B, attention is paid to the band area 321. In the recognizing process, a collating process of predetermined partial areas (hereinbelow, called matching areas) in the band areas 311 and 321 and a recognition target is executed. The matching areas are, for example, the areas as illustrated at 312 and 313 and are moved as shown by an arrow 314. More specifically describing, the movement is started from a position of 312 in the band area 311 and the matching area is moved one pixel by one in the lateral direction to a position of 313 at a right edge. After the matching area reached the right edge, it is returned to a left edge, moved downward by one pixel, and moved again from the left edge to the right edge. The movement of the matching area is repeated to a right lower edge of the band area 311 and the recognizing process is executed in each area. Subsequently, a data transfer in the band area 311 will be described. The movement of the matching area as shown by the arrow 314 can be realized by transferring the data in raster scanning order shown by an arrow 316. For example, at a point of time when a matching area 317 is processed, image data of a hatched portion 315 is held in a memory. In order to move the matching area 317 to a position in the right direction by one pixel, image data at a position of 319 is thrown away and image data at a position of 318 is read.

FIGS. 5A to 5C are diagrams illustrating the example in which the image 300 is divided into band areas in the lateral direction and the recognizing process is executed to two band areas 411 and 421. In FIG. 5A, attention is paid to the band area 411. In FIG. 5B, attention is paid to the band area 421. Matching areas of the band area 411 are, for example, the areas as illustrated at 412 and 413 and are moved as shown by an arrow 414. More specifically describing, the movement is started from a position of 412 in the band area 411 and the matching area is moved one pixel by one in the vertical direction to a position of 413 at a lower edge. After the matching area reached the lower edge, it is returned to an upper edge, moved in the right direction by one pixel, and moved again from the upper edge to the lower edge. The movement of the matching area is repeated to a right lower edge of the band area 411 and the recognizing process is executed in each area. A data transferring method of performing the movement of the matching area as mentioned above is similar to that in the case of FIGS. 4A to 4C and can be realized by the scan in the vertical direction shown by an arrow 416. If there is a memory which can temporarily hold image data of a hatched portion 415, the recognizing process of a matching area 417 can be performed.

However, in order to execute the recognizing process between the band areas without a gap, the band areas have to be constructed in such a manner that parts of the band areas overlap mutually at a boundary between each band area and its adjacent area. In the case of the band division in the vertical direction, an area shown at 331 overlaps in the band areas 311 and 321 as illustrated in FIG. 4C. In the case of the band division in the lateral direction, an area shown at 431 overlaps in the band areas 411 and 421 as illustrated in FIG. 5C. The above overlapped area is called an overlap area hereinbelow.

In the case where the area was divided into the band areas in the vertical direction, a size of (width of matching area)×(height of band area) is needed as an overlap area 331. In the case where the area was divided into the band areas in the lateral direction, a size of (height of matching area)×(width of band area) is needed as an overlap area 431. As for a data transfer amount in the case where the image 300 is divided into the band areas and transferred from an external memory to an internal memory, in addition to the data transfer of the image 300, a transfer overhead of the overlap areas 331 and 431 is necessary.

If a shape of the image is fixed, it is sufficient to preliminarily install the image according to its shape by a transferring method of a small transfer overhead. However, since a shape of change area which is detected by the background difference varies every frame, there is such a problem that the transferring method of the small transfer overhead cannot be unconditionally determined. For example, if a change area which is laterally long was detected, when the change area is band-divided in the lateral direction, there is a case where the transfer overhead is smaller than that in the case of band-dividing in the vertical direction. On the contrary, if a change area which is vertically long was detected, when the change area is band-divided in the vertical direction, there is a case where the transfer overhead is smaller than that in the case of band-dividing in the lateral direction.

### SUMMARY OF THE INVENTION

It is an object of the invention to minimize a transfer overhead which is caused when image data is divided and transferred.

To solve the above problem, the present invention provides an image processing apparatus comprising: a detection unit configured to detect an area having a predetermined feature from image data; a selection unit configured to select, based on information of the area detected by the detection unit, a transfer method in which a total transfer amount of data is smallest from a plurality of transfer methods whereby the data of the detected area is divided and transferred; and a transfer unit configured to divide the data of the detected area and transfer from a first storage device in which the image data has been stored to a second storage device by the transferring method selected by the selection unit.

Further features and aspects of the present invention will become apparent from the following detailed description of exemplary embodiments with reference to the attached drawings.

### BRIEF DESCRIPTION OF THE DRAWINGS

FIG. 1 is a diagram illustrating an example of a construction of an image processing apparatus.

FIG. 2 is a flowchart illustrating an example of a recognizing process.

FIGS. 3A and 3B are diagrams for describing parameters of a transfer amount calculation.

FIGS. 4A, 4B and 4C are diagrams for describing a method of band-dividing an input image in the vertical direction.

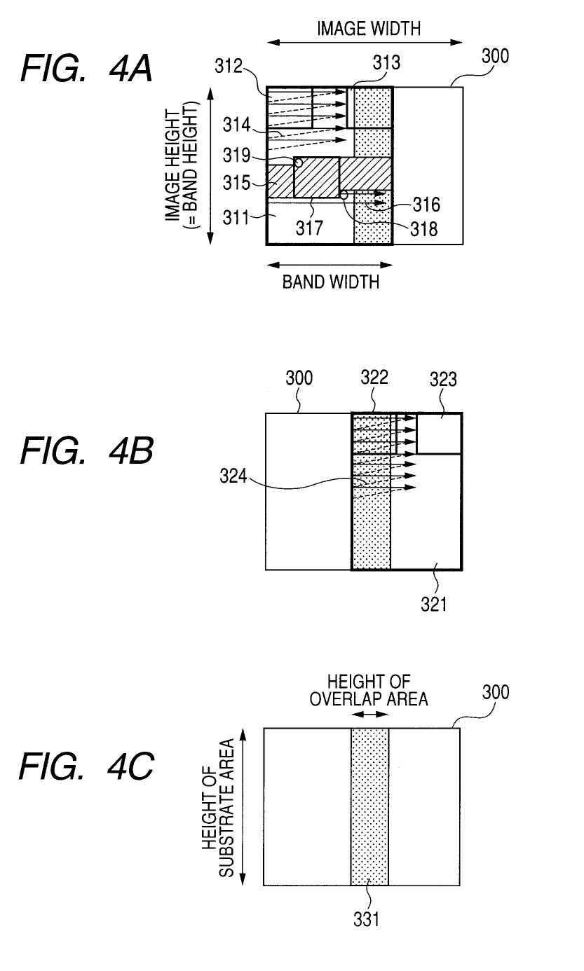

FIGS. 5A, 5B and 5C are diagrams for describing a method of band-dividing an input image in the lateral direction.

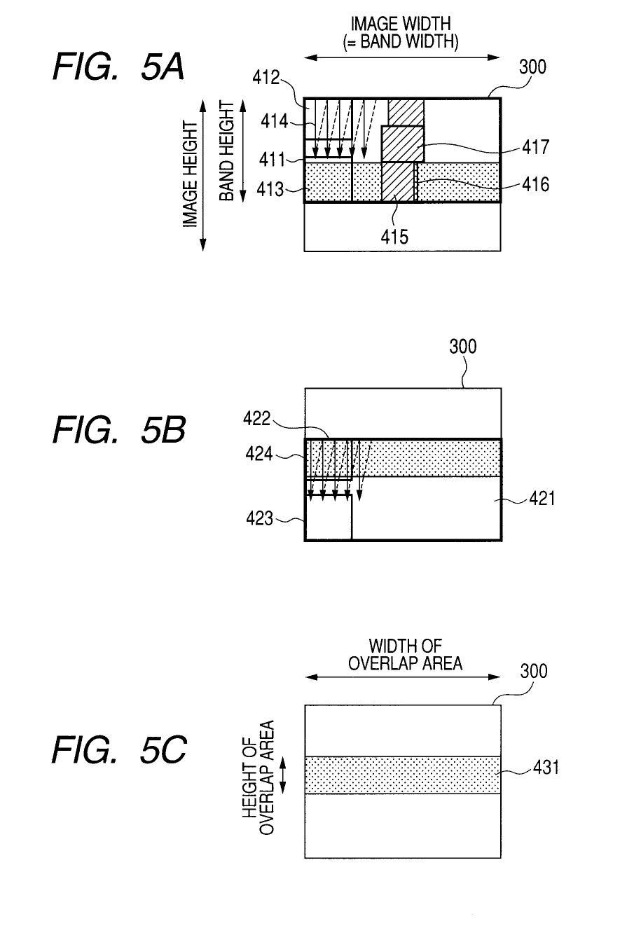

### DESCRIPTION OF THE EMBODIMENTS

Embodiments of the invention will be described hereinbelow with reference to the drawings.

### Embodiment 1

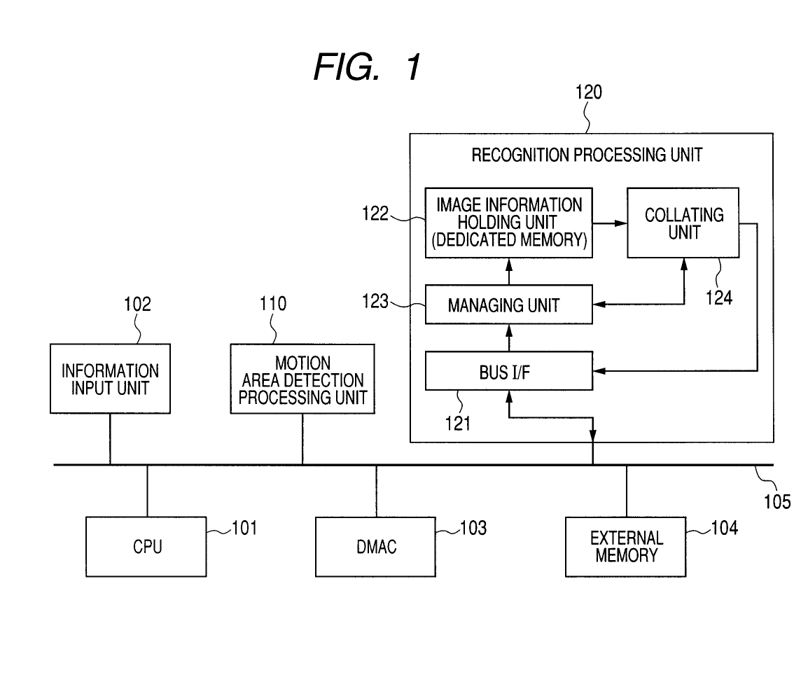

FIG. 1 is a diagram illustrating an example of a construction of an image processing apparatus.

A CPU 101 controls each unit which is connected through a bus 105. An information input unit 102 fetches input image data serving as a processing target into the image processing apparatus. The information input unit 102 may be constructed by, for example, an image sensor such as a CCD or may be an I/F apparatus for receiving data to be processed from an external apparatus through a predetermined communication path such as a network. An external memory 104 is constructed by a storage device such as RAM or HDD and is connected to the bus 105. The external memory 104 is used as a storing area of a program for making the CPU 101 operative or a work area which is used when various kinds of processes are executed. The external memory 104 is also used as an area for holding input image information (image data) as necessary. The external memory 104 is an example of first storing means.

A motion area detection processing unit 110 is connected to the bus 105, can access the external memory 104, and operates by an instruction from the CPU 101. A DMA controller (DMAC) 103 can independently and continuously perform the data transfer among the information input unit 102, the external memory 104, and a recognition processing unit 120, which will be described hereinafter, when the CPU 101 sets and instructs such an operation. After completion of the instructed transferring operation, the DMA controller 103 notifies the CPU 101 of an interruption signal.

The recognition processing unit 120 is constructed by a bus I/F 121 for connecting to the bus 105, an image information holding unit 122, a managing unit 123, and a collating unit 124. The recognition processing unit 120 processes image data which is transferred from the external memory 104 by the DMAC 103 and writes a detection result into the external memory 104. The image information holding unit 122 is a dedicated memory for holding predetermined matching areas to be collated with the recognition target. The image information holding unit 122 is an example of second storing means. The collating unit 124 repeats the collating process with the recognition target for the matching areas held in the image information holding unit 122 and discriminates whether or not the image in the matching area is the recognition target. The managing unit 123 manages the writing of the image data which is held in the image information holding unit 122 and manages the start and end of the process in the collating unit 124.

Subsequently, the operation will be described.

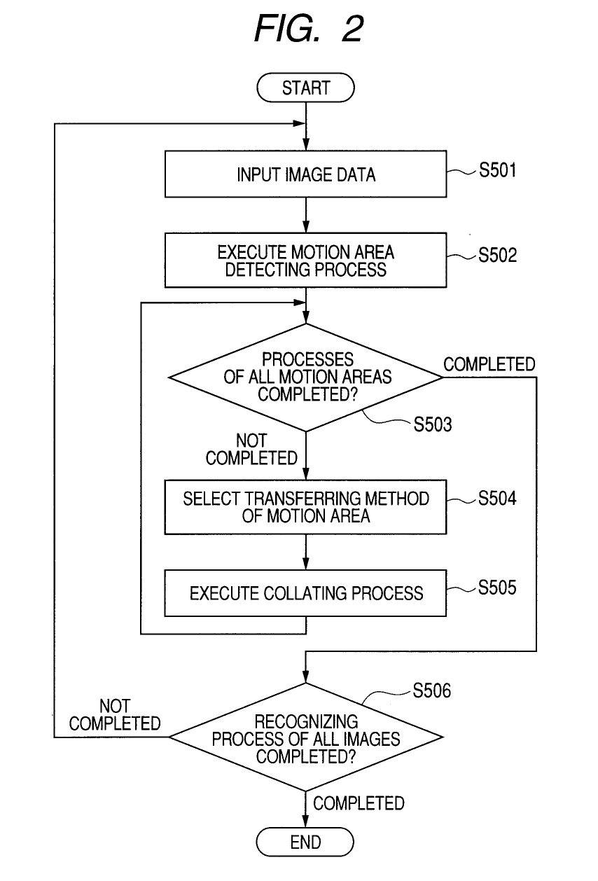

FIG. 2 is a flowchart illustrating an example of the recognizing process.

In the embodiment, image information which is input to the image processing apparatus is a plurality of image data (motion images) which are time-sequentially arranged.

S501 denotes a step of inputting the image information. The information input unit 102 inputs the image data adapted to execute the recognizing process and stores into a predetermined memory.

S502 denotes a step of executing a motion area detecting process. The motion area detection processing unit 110 analyzes the motion image which is input and detects an area where an image of a present frame changes from a background image (hereinbelow, such an area is called a motion area). Information of the detected motion area is held into the external memory 104 or the like and is referred to in the next step.

S503 denotes a step of discriminating whether or not the collating process of all areas has been completed. If the collating process of all of the areas has been completed, the motion area detection processing unit 110 shifts the process to S506. If the motion area is not detected in S502, since the collating process is unnecessary, the motion area detection processing unit 110 determines that the collating process has been completed. If the collating process is not completed, the motion area detection processing unit 110 shifts the process to next step S504.

S504 denotes a step of selecting a transferring method of the motion area detected in S502. In S504, for example, the CPU 101 calculates a transfer overhead by using a shape of motion area and selects the transferring method in which the transfer overhead is smallest from a plurality of transferring methods. The process of S504 will be described in detail hereinafter.

S505 denotes a step of reading out the image data according to the transferring method selected in S504 and executing the collating process. The process of S505 will be described in detail hereinafter.

After completion of the collating process of S505, the processing routine advances to S503 and, for example, the motion area detection processing unit 110 discriminates whether or not the collating process of all of the areas has been completed.

S506 denotes a step of discriminating whether or not the recognizing process of all images has been completed. If the recognizing process of all of the images is not finished, the recognizing process is not completed and the recognition processing unit 120 shifts the process to step S501. If the recognizing process of all of the images has been finished, the recognizing process has been completed and the recognition processing unit 120 finishes the processing routine shown in FIG. 2.

Subsequently, the processes of S501 to S502 will be described in detail.

In S501, the information input unit 102 inputs the image data and stores into the external memory 104 through the bus 105. After completion of the storage of the image data, the information input unit 102 notifies the CPU 101 of the interruption signal. When the notification is received, the CPU 101 sets information of a storage destination of the image data in the external memory 104 into the motion area detection processing unit 110 and generates a command for starting the motion area detecting process.

Subsequently, in S502, the motion area detection processing unit 110 obtains a difference between the background image and the input image, further obtains a rectangle which surrounds the area in which the difference exists, and detects it as a motion area. The motion area detection processing unit 110 stores position information of the detected motion area into a predetermined address in the external memory 104 in correspondence to the input image. The position information of the motion area is information in which four corner points of a rectangular area are expressed by coordinates in which a left upper position of the image is set to an origin. There is also a case where a plurality of motion areas are detected from one image. Although there is naturally a case where no motion image is found out, in such a case, there is no output of the position information. After completion of the instructed process, the motion area detection processing unit 110 notifies the CPU 101 of the interruption signal.

Subsequently, the operation of S503 to S506 will be described in detail.

In S503, after the CPU 101 received the interruption signal of the completion of the process from the motion area detection processing unit 110, whether or not it is necessary to execute the recognizing process is discriminated from the position information of the motion area stored in the external memory 104. If there is no position information of the motion area, the CPU 101 shifts the process to S506. In S506, for example, whether the recognition processing unit 120 or the CPU 101 which received the notification from the recognition processing unit 120 finishes the process of all of the images or processes the next input image is discriminated. If the next input image is processed, for example, the CPU 101 shifts the process to S501. That is, a process for inputting the next input image from the information input unit 102 is executed.

If the position information of the motion area exists, the CPU 101 shifts the process to S504 and S505 for executing the collating process to each of the recorded motion areas.

In S504, the CPU 101 calculates the total transfer amount of the image data in the case where the image of the motion image is band-divided in the vertical direction and transferred and that in the case where the image of the motion image is band-divided in the lateral direction and transferred. The CPU 101 sets the DMAC 103 in such a manner that the image data of the motion image is extracted from the image data stored in the external memory 104 based on the position information of the motion area and is transferred to the recognition processing unit 120 by the selected band dividing method. Then, the CPU 101 generates a command to start the transfer.

A more specific calculating equation of a total transfer amount of the image data in order to select the transferring method in S504 will be described. The method of band-dividing the motion area in the vertical direction and the lateral direction which is used here is as described in the related art.

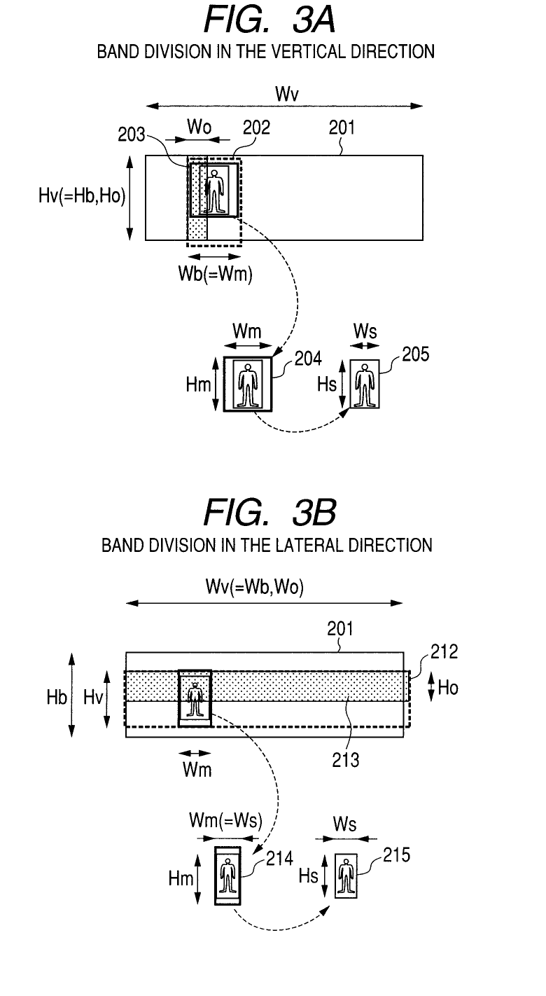

First, a calculating method of the total transfer amount of the image data in the case where the motion area has been band-divided in the vertical direction will be described with reference to FIG. 3A.

A motion area 201 detected by the motion area detection processing unit 110 is illustrated and corresponds to the image data in the case where a width of motion area is set to Wv and its height is set to Hv. An area 202 surrounded by a broken line is a band area obtained when the motion area has been band-divided in the vertical direction and corresponds to the area in which a band width is set to Wb and a band height is set to Hb. A meshed area 203 is an overlap area in which a width is set to Wo and a height is set to Ho. When the motion area is band-divided in the vertical direction, the band height Hb is equal to the same value as that of the height Hv of motion area and that of the height Ho of overlap area. A matching area 205 to be subjected to the recognizing process is an area in which a width is set to Ws and a height is set to Hs. An area 204 of the image data which is stored in the dedicated memory of the image information holding unit 122 is an area in which a width is set to Wm and a height is set to Hm. A size of dedicated memory of the image information holding unit 122 is assumed to be Sm. Since Sm is ordinarily fixed after hardware was formed, it can be handled as a fixed value.

Subsequently, a method whereby a total transfer amount in the case where the motion area 201 was band-divided in the vertical direction and transferred from the external memory 104 to the recognition processing unit 120 is calculated by using the foregoing information will be described.

First, the width Wm and height Hm of the area which is stored in the dedicated memory are calculated. Since it is sufficient that the height Hm of area which is stored in the dedicated memory is equal to the height of matching area,

Hm=Hs (1)

Since the memory size Sm is fixed, the width Wm of area which can be stored in the dedicated memory is equal to

Wm=Sm/Hm (2)

where, Wm is a positive integer.

Subsequently, the width Wo of overlap area is calculated. The width Wo of overlap area is determined by the width Ws of matching area and is equal to

Wo=Ws−1 (3)

If Wm and Wo are decided, a band dividing number N of band areas which are divided from the motion area 201 is determined. The band dividing number N is expressed by

N=(Wv−(Ws−1))/(Wm−Wo) (4)

where, the division is performed on the assumption that fractions below a decimal point are rounded up.

A total size So of overlap areas in the motion area is calculated as follows by using the band dividing number N obtained by the equation (4).

So=(N−1)×Hv×Wo (5)

Since a total transfer amount Sv is equal to a size obtained by adding the total size So of overlap areas in the motion area obtained by the equation (5) and the size of motion area, it is equal to

Sv=So+Wv×Hv (6)

The total transfer amount at the time when the motion area has been band-divided in the vertical direction and transferred can be calculated by using the above equations (1) to (6).

Now, assuming that one recognition target has been predetermined, since the shape of matching area is decided by the recognition target, Ws and Hs are set to the fixed values and variables in the equations (1) to (6) become only two variables of the width Wv and the height Hv of the motion area. The CPU 101 obtains the information of Wv and Hv from the position information of the motion area which was read out by the CPU 101 and can calculate the total transfer amount.

Subsequently, a calculating method of the total transfer amount of the image data in the case where the motion area has been band-divided in the lateral direction will be described with reference to FIG. 3B.

The motion area 201 is the same as that described in FIG. 3A. An area 212 surrounded by a broken line is a band area obtained when the motion area has been band-divided in the lateral direction and corresponds to the area in which a band width is set to Wb and a band height is set to Hb. A meshed area 213 is an overlap area in which a width is set to Wo and a height is set to Ho. When the motion area is band-divided in the lateral direction, the band width Wb is equal to the same value as that of the width Wv of motion area and that of the width Wo of overlap area. A matching area 215 to be subjected to the recognizing process is an area in which a width is set to Ws and a height is set to Hs. An area 214 of the image data which is stored in the dedicated memory of the image information holding unit 122 is an area in which a width is set to Wm and a height is set to Hm. A size of dedicated memory of the image information holding unit 122 is assumed to be Sm similar to that in the description about the band division in the vertical direction and is handled as a fixed value.

Subsequently, a method whereby a total transfer amount in the case where the motion area 201 was band-divided in the lateral direction and transferred from the external memory 104 to the recognition processing unit 120 is calculated by using the foregoing information will be described.

First, the width Wm and height Hm of the area which is stored in the dedicated memory are calculated. Since it is sufficient that the width Wm of area which is stored in the dedicated memory is equal to the width of matching area,

Wm=Ws (7)

Since the memory size Sm is fixed, the height Hm of area which can be stored in the dedicated memory is equal to

Hm=Sm/Wm (8)

where, Hm is a positive integer.

Subsequently, the height Ho of overlap area is calculated. The height Ho of overlap area is determined by the height Hs of matching area and is equal to

Ho=Hs−1 (9)

If Hm and Ho are decided, the band dividing number N of band areas which are divided from the motion area 201 is determined. The band dividing number N is expressed by

N=(Hv−(Hs−1))/(Hm−Ho) (10)

where, the division is performed on the assumption that fractions below a decimal point are rounded up.

The total size So of overlap areas in the motion area is calculated as follows by using the band dividing number N obtained by the equation (10).

So=(N−1)×Wv×Ho (11)

Since a total transfer amount Sh is equal to a size obtained by adding the total size So of overlap areas in the motion area obtained by the equation (11) and the size of motion area, it is equal to

Sh=So+Wv×Hv (12)

The total transfer amount at the time when the motion area has been band-divided in the lateral direction and transferred can be calculated by using the above equations (7) to (12).

Now, assuming that one recognition target has been predetermined, since the shape of matching area is decided by the recognition target, Ws and Hs are set to the fixed values and variables in the equations (7) to (12) become only two variables of the width Wv and the height Hv of the motion area. The CPU 101 obtains the information of Wv and Hv from the position information of the motion area which was read out by the CPU 101 and can calculate the total transfer amount.

Subsequently, a more specific example of the total transfer amount of the image data in the case where the motion area has been band-divided in the vertical direction and that in the case where the motion area has been band-divided in the lateral direction will be described.

First, it is assumed as a prerequisite of the above example that one pixel is a gray scale image of one byte. It is also assumed that the memory size Sm of the installed image information holding unit 122 is equal to 5000 bytes and the shape of matching area as a recognition target is set to Ws=50 pixels and Hs=80 pixels.

Now, assuming that the shape of motion area obtained by the motion area detecting process is set to Wv=600 pixels and Hv=200 pixels, the total transfer amount of the motion area is equal to 531,600 bytes in the case where the motion area was band-divided in the vertical direction, and is equal to 357,000 bytes in the case where the motion area was band-divided in the lateral direction. It will be understood that if the motion area has a shape of 600×200 pixels which is laterally long, the total transfer amount in the case where the motion area was band-divided in the lateral direction is smaller than that in the case where the motion area was band-divided in the vertical direction. On the other hand, now assuming that the shape of motion area is set to Wv=200 pixels and Hv=600 pixels, the total transfer amount of the motion area is equal to 443,400 bytes in the case where the motion area was band-divided in the vertical direction and is equal to 499,200 bytes in the case where the motion area was band-divided in the lateral direction. It will be understood that if the motion area has a shape of 200×600 pixels which is vertically long, the total transfer amount in the case where the motion area was band-divided in the vertical direction is smaller than that in the case where the motion area was band-divided in the lateral direction.

Subsequently, the operation of the recognition processing unit 120 of S505 will now be described.

After the transferring method was decided, the CPU 101 sets the DMAC 103 and starts the transfer of the image data from the external memory 104 to the image information holding unit 122. However, before the transfer of the image data by the DMAC 103 is started, the CPU 101 sets the information of the transferring method into the managing unit 123 through the bus I/F 121. When the transfer of the image data by the DMAC 103 is started, the image data is input from the external memory 104 to the managing unit 123 through the bus 105 and the bus I/F 121.

The managing unit 123 corresponds to the transfer of the image data according to the band-dividing direction, calculates an address of a storage destination in each transferring method, and writes the image data into the image information holding unit 122. After the image data of an amount corresponding to the matching area was accumulated, the managing unit 123 stops the transfer of the image data and issues a command to the collating unit 124 so as to start the process. After the command was issued, the managing unit 123 waits for the end of the operation of the collating unit 124. The collating unit 124 executes a process for detecting the recognition target by using the image data of the matching area held in the image information holding unit 122. A detection result is written into a predetermined address in the external memory 104 from the collating unit 124 through the bus I/F 121 and the bus 105. After the process was finished, the collating unit 124 notifies the managing unit 123 of such a fact. When an end notification is received, the managing unit 123 restarts the transfer of the image data which was stopped in order to store the image data of the next matching area into the image information holding unit 122. The above operation is repeated until the transfer of one motion area is finished. When it is finished, the DMAC 103 notifies the CPU 101 of such a fact through the bus 105.

As mentioned above, by changing the operating mode to either the mode of band-dividing in the vertical direction or the mode of band-dividing in the lateral direction according to the shape of motion area, the size of overlap area can be suppressed.

In the embodiment, when the total transfer amount of the image data is calculated, only the width Wv and the height Hv of the motion area in the calculating equations are handled as variables. This means that the variable parameters are not limited but the total transfer amount may be obtained by handling both of the width Ws and the height Hs of the matching area as variables.

In the embodiment, the total transfer amount is calculated from the shape of motion area serving as an input image and the band-dividing method is selected. However, it is also possible to construct in such a manner that all total transfer amounts are preliminarily calculated from the width and height of the motion area and held as a table and the band-dividing method in which the total transfer amount is smallest is selected with reference to the table.

### Other Embodiments

The invention is also realized by executing the following processes. That is, software (program) for realizing the functions of the embodiment mentioned above is supplied to a system or an apparatus through a network or various kinds of storage media, and a computer (or CPU, MPU, or the like) of the system or apparatus reads out the program and executes processes corresponding to the read-out program.

According to each of the foregoing embodiments, the transfer overhead which is caused when the image data is divided and transferred can be minimized.

Although the exemplary embodiments of the invention have been described in detail above, the invention is not limited to the specific embodiments but many modifications and variations are possible within the scope of the spirit of the invention disclosed in claims.

For example, the above embodiments have been described by using the example in which the motion area is detected as an example of predetermined features from the image data and the image data is transferred. However, such an example does not limit the above embodiments. For example, in the case where an area in which there is no motion for a predetermined time or longer is detected as an example of predetermined features from the image data and the image data is transferred or the like, similar advantages can be obtained by processes similar to those in the foregoing embodiments.

Various exemplary embodiments, features, and aspects of the present invention will now be herein described in detail below with reference to the drawings. It is to be noted that the relative arrangement of the components, the numerical expressions, and numerical values set forth in these embodiments are not intended to limit the scope of the present invention.

Aspect of the present invention can also be realized by a computer of a system or apparatus (devices such as a CPU or MPU) that reads out and executes a program recorded on a memory device to perform the functions of the above-described embodiments, and by a method, the steps of which are performed by a computer or a system or apparatus by, for example, reading out and executing a program recorded on a memory device to perform the functions of the above-described embodiments. For this purpose, the program is provided to the computer for example via a network or from a recording medium of various types serving as the memory devices (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-240636, filed Oct. 19, 2009, which is hereby incorporated by reference herein in its entirety.

What is claimed is:

1. An image processing apparatus comprising:
a detection unit configured to detect an area having a predetermined feature from image data;
a selection unit configured to select, based on information of the area detected by the detection unit, a transfer method in which a total transfer amount of data is smallest from a plurality of transfer methods whereby the data of the detected area is divided and transferred; and
a transfer unit configured to divide the data of the detected area and transfer from a first storage device in which the image data has been stored to a second storage device by the transferring method selected by the selection unit.

2. An apparatus according to claim 1, wherein based on the information of the area detected by the detection unit, the selection unit obtains the total transfer amount of the data at the time when the data of the area is divided and transferred in each of the plurality of transfer methods and selects the transfer method in which the obtained total transfer amount is smallest.

3. An apparatus according to claim 1, wherein based on the information of the area detected by the detection unit, the selection unit selects the transfer method in which the total transfer amount of the data at the time when the data of the detected area is divided and transferred is smaller between the transfer method whereby the image data is band-divided in the vertical direction and transferred and the transfer method whereby the image data is band-divided in the lateral direction and transferred.

4. An apparatus according to claim 1, wherein based on a width and a height of the area as information of the area detected by the detection unit, the selection unit selects the transfer method in which the total transfer amount of the data at the time when the data of the area is divided and transferred is smallest among the plurality of transfer methods.

5. An apparatus according to claim 1, further comprising a collation unit configured to execute a collation process of an area shown by the data stored in the second storage device and a matching area, and
wherein based on the information of the area detected by the detection unit and the information of the matching area, the selection unit selects the transfer method in which the total transfer amount of the data at the time when the data of the area is divided and transferred is smallest among the plurality of transfer methods.

6. An apparatus according to claim 5, wherein based on a width and a height of the area as information of the area detected by the detection unit and a width and a height of the matching area as information of the matching area, the selection unit selects the transfer method in which the total transfer amount of the data at the time when the data of the area is divided and transferred is smallest among the plurality of transfer methods.

7. An apparatus according to claim 1, wherein the detection unit detects a motion area as an area having the predetermined feature from the image data.

8. An image processing method comprising:
detecting an area having a predetermined feature from image data;
selecting, based on information of the detected area, a transfer method in which a total transfer amount of data is smallest from a plurality of transfer methods whereby the data of the detected area is divided and transferred; and
dividing the data of the detected area and transferring from a first storage device in which the image data has been stored to a second storage device by the selected transferring method.
